(19) United States
(12) Patent Application Publication
(10) Pub. No.: US 2012/0010890 A1
(43) Pub. Date: Jan. 12, 2012

(54) POWER-OPTIMIZED WIRELESS COMMUNICATIONS DEVICE

(76) Inventor: Raymond Clement Koverzin, San Jose, CA (US)

(21) Appl. No.: 13/142,853

(22) PCT Filed: Dec. 30, 2009
(86) PCT No.: PCT/US09/69763

§ 371 Date: Sep. 28, 2011

Related U.S. Application Data
(60) Provisional application No. 61/141,601, filed on Dec. 30, 2008.

(51) Int. Cl. G10L 21/00

(52) U.S. Cl. 704/275; 704/E21.001

(57) ABSTRACT

The present invention is an Always On, Hands-free, Speech Activated, Power-optimized Wireless Communications Device with associated base. The unique value of the device is that a person can use the device at any time, 24×7, with hands-free operation. People can wear it 24×7 on their body either around their neck or on their wrist or wherever it best meets their needs. Speech activation provides greater convenience for the person in using the wireless communications device, and at the same time, it allows the microcontroller greater control of power consuming resources. The wireless communications device may host simple, low power applications. In addition, applications will reside in the base, and in an application (either voice or data) server that is accessed by the wireless communications base.

### CROSS-REFERENCE TO RELATED APPLICATIONS

This application claims the priority of U.S. Provisional Patent Application No. 61/141,601 filed Dec. 30, 2008.

TECHNICAL FIELD

The present invention is in the technical field of wireless communicating devices.

### BACKGROUND OF THE INVENTION

We live in a world of wireless devices. The first popular wireless device was the one-way pager a few decades ago. This allowed people to be contacted by clients or colleagues while they were away from the office. Typically, a person who received the page would find the nearest payphone to call an answering service in order to retrieve a message. In the 1970s, a new voice communications device, called the cell phone, allowed one to make and receive voice calls away from their home or office. These devices were very expensive, generally had poor audio quality, and required large batteries that provided typically very short talk times and quite short standby times.

Each successive generation of wireless devices (one way then two way message pagers, mobile phones) focused on reduced size, better displays, more features, and longer battery life.

Similarly, the plain old telephone sets in the home gave way to feature-rich cordless phones. They, too, evolved from simple voice communication devices to capabilities that are nearly the same as mobile phones but are not nearly as restrictive in size, features, and battery life.

Cordless phones and mobile phones operate in a similar manner. To make a call, the user must enter in a telephone number and press talk or send to initiate a call. They both can receive calls simply by pressing the answer button when the device rings.

In either case, the user must physically press the “send” or “answer” button to establish a voice connection with the other party. In a mobile phone, the voice connection is established wirelessly to a cell phone tower located somewhere in the neighborhood and typically routed over the landline phone network to the other party. In a cordless phone, the voice connection is established wirelessly to the cordless phone base, with the base connecting to the telephone line in one's house.

Both wireless devices have two modes of operation; standby mode and talk mode. In standby mode, the device is periodically sending a beacon signal to the base indicating that it is available to receive calls. In talk mode, a two-way voice channel is established between the wireless device and a base. Compared to standby mode, talk mode requires much more battery power to sustain the voice channel to the base. This can be more than 10 times the power required to sustain standby mode.

Another feature that some mobile phones have is push to talk. Push to talk (similar to walkie-talkies) provides a relatively simple means of sending a brief voice message to one or more similar devices. The mobile phone would have pre-programmed “group lists” to select from before sending a push to talk voice message. The recipients can respond in kind by pressing a button on their mobile phone to send back a short voice message.

Another common feature is speakerphone or hands-free mode. The microphone is sensitive enough to pick up the person's voice in the immediate area and the speaker on the device is powerful enough for the user to hear what the person at the other end of the call is saying.

Another feature that is being introduced is fixed function, limited vocabulary speech recognition. The speech recognition feature requires that the user press a button or a sequence of buttons to engage this feature on the communications device.

Another feature that has been introduced to wireless devices is the use of computer generated speech to provide indicators to users. Computer generated speech can be provided by speech synthesis or by playing recorded speech segments to the user.

In summary, today's wireless devices focus on including a multitude of features and integrated applications requiring manual (and generally complex) interaction via tiny keyboards and tiny displays. Some of this manual interaction has been reduced by the use of a limited use speech recognition facility for specific onboard applications. Continuous speech recognition on a wireless device is problematic since this requires a large amount of computer processing power which in turn results in relatively short periods of usage time between battery recharging. Continuous speech recognition could be made available to the wireless device by establishing a continuous speech path to its base whereby the base does the processing of speech data into text, but maintaining a continuous wireless connection quickly draws down the battery of the wireless device and thus will require either a larger battery as part of the wireless device or would require the user to more frequently recharge the device between use. Additionally, battery power draw will be substantial regardless if speech or silence is being transported over the established wireless voice path.

Generally, the goal of an advanced wireless communication device is to provide the user with as broad an access to applications and information in the smallest, most user-friendly package that he/she can carry around while minimizing the requirement of frequent battery recharging.

### BRIEF SUMMARY OF THE INVENTION

The present invention is an Always On, Hands-free, Speech Activated, Power-optimized Wireless Communications Device with associated base. The unique value of the device is that a person can use the device at any time, 24×7, with hands-free operation. People can wear it 24×7 on their body either around their neck or on their wrist or wherever it best meets their needs. It can be placed on a battery charging appliance located beside the person's bed while they sleep but still have the wireless device available for use at any time while the battery is recharging.

The device is as small as possible while still meeting the communications and applications needs of the person.

The device size and weight will be significantly affected by the size and weight of battery used. A bigger battery allows for longer use between charges. Through power optimization, as this invention provides, the size of the battery can be greatly reduced to deliver the always on, hands-free, speech activated wireless communications device. Speech activation eliminates the need to power on (since the invention is always on and in a low power state), to manually establish a voice connection and to manually disconnect when no longer needed. Not only does always on and speech activation provide greater convenience for the person in using the wireless communications device but it allows for greater control of power consuming resources, mainly the radio interface, within the device.

In some embodiments of this invention, the wireless communications device may host simple, low power applications. In other embodiments, such applications will reside in the base, or in an application (either voice or data) server that is accessed via the wireless communications base.

### BRIEF DESCRIPTION OF THE SEVERAL VIEWS OF THE DRAWING

FIG. 1 is a general view of the wireless communicator and associated base, and externally connected equipment.

FIG. 2 is an exploded view of the wireless communicator

FIG. 3 is the state machine of the wireless communicator

FIG. 4 is an exploded view of the associated base

FIG. 5 is the state machine of the associated base

### DETAILED DESCRIPTION OF THE INVENTION

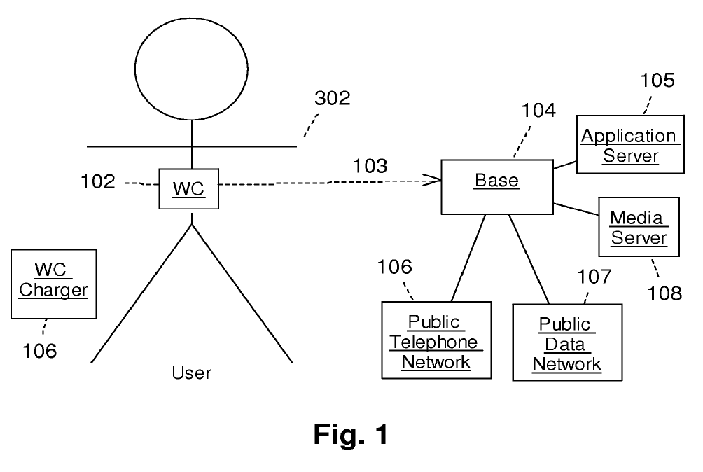

FIG. 1 provides a general view of the invention, the wireless communicator 102 and associated base 104. The base connects to a variety of external voice and data systems and services, as needed. The wireless communicator 102 is attached on or is near the body of the user 101 in order to pick up the user's speech and to be heard by the user via the integrated speaker. The wireless communicator 102 may be attached to the clothes of the user 101. The wireless communicator 102 must be within radio contact range of the base 104 in order to establish a proper wireless speech path. The base 104 provides applications to the user 101 through the wireless communicator. The application server 105 is associated with base 104 in order to provide other applications desired by the user 101. The base 104 provides access to the telephone network 106 and the data network 107 to allow the user 101 to communicate by voice or to access data resources as managed by an application running on the base 104 and serving the user 101. Additionally, the base provides access to a variety of external media servers 108 supporting audio-based applications like IVR/voicemail, Dictaphone service, and podcasts/music. The wireless communicator 102 makes use of the wireless communicator charger 106 to recharge its battery while still being operational.

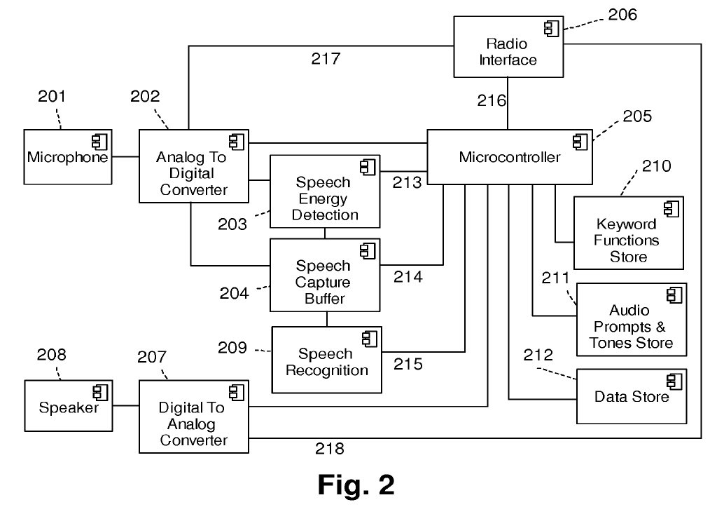

FIG. 2 identifies the components that make up the wireless communicator. Audio can be fed by the radio interface 206 or the microcontroller 205 as a stream of binary data representation to a digital to analog converter or DAC 207. The DAC 207 outputs an analog signal which drives the speaker 208. The analog signal can be amplified as necessary. The microphone 201 continuously picks up sound in the immediate environment. The analog to digital converter or ADC 202 converts the analog signal from the microphone 201 into a binary digit representation. The speech energy detection 203 circuit continuously analyzes the ADC 202 output and over a number of successive samples determine if there is speech energy detected above a predefined threshold. The speech capture buffer 204 circuit is engaged at the beginning of detecting sufficient speech energy, and is turned off when detected speech energy drops below the predefined threshold. While engaged, the speech capture buffer 204 stores all output from the ADC 202. Additionally, the speech capture buffer 204 can be continuously engaged in recording speech data for use in other applications.

While in the idle state, the microcontroller 205 is designed such that it is sleeping which conserves battery power. The microcontroller 205 periodically wakes up and initiates a “ping” indicating to the base 104 that it is still within range and available for service and goes back to sleep after receiving a response.

The microcontroller 205 is signaled 216 by the Radio Interface 206 when the base 104 wishes to establish a speech path with the wireless communicator 102.

Additionally, the microcontroller 205 may have previously requested that the speech recognition 209 circuit be enabled to translate the captured speech into one of a small set of specific keyword phrases. Upon a successful translation match 215, the microcontroller 205 will be notified of the match 215 and be presented with the matched phrase.

Additionally, when the speech recognition 209 circuit is not enabled, the microcontroller 205 is signaled 213 by the speech energy detection circuit 203 when the speech energy threshold is met and when the speech energy detection falls below the threshold.

The purpose of the speech capture buffer 204 is to permit, beyond just keyword speech recognition, additional analysis locally to the wireless communicator 102 or to have the captured speech be forwarded to the base 104 for analysis or use.

Upon receiving any of these signals via 213, 214, 215, the microcontroller 205 is woken up and initiates an appropriate function. The keyword function store 210 contains the code for use by the microcontroller 205. Audio prompts and tone store 211 contains speech prompts and tone indicators that can be played to the user 102 as necessary or in the execution of a function. The data store 212 contains necessary state information needed by the microcontroller for normal operation and normal execution of any of the functions.

Another embodiment of the wireless communicator 102 is a communicator that has full speech recognition capabilities. Such a communicator will be capable of carrying out a wide variety of speech-related applications, with no, or minimal, involvement of the base.

Another embodiment of the invention is the separation of the microphone 201 and ADC 202 from the wireless communicator 102 as a separate “button-sized” wireless microphone device using a very low power microcontroller and radio interface typically covering the range of the user's body. In this embodiment, the wireless communicator 102 would have an additional radio interface that communicates with the radio interface of the button microphone. This button microphone provides greater flexibility in placement near the user's mouth due to its smaller size and the placement of the associated wireless communicator on the body. The wireless communicator 102 could also be placed near the person, such as near the person's bed when the person is sleeping.

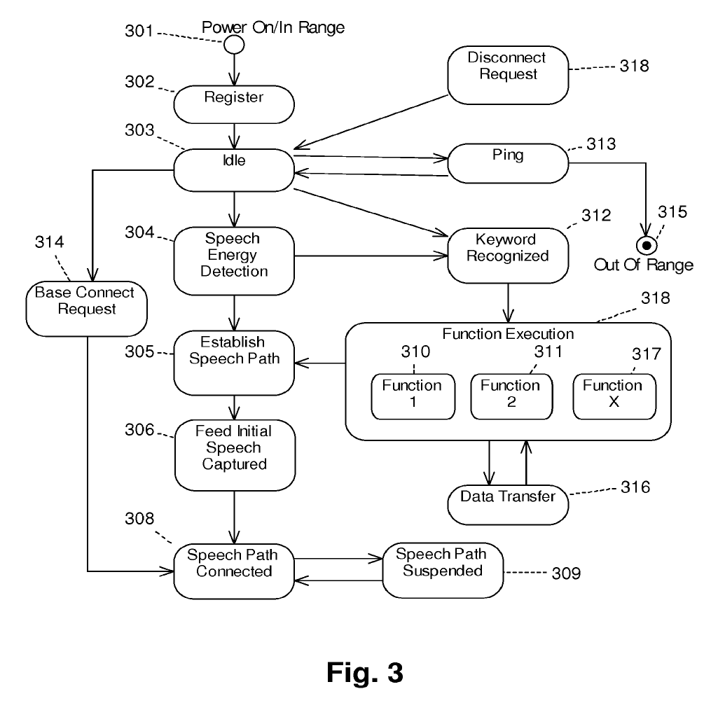

FIG. 3 identifies the general state machine executed by the microcontroller 205. The radio interface 206 uses commercial digital wireless technology available today that supports voice and data transmission. The microcontroller 205 waits to receive 301 the signal from the radio interface 206 indicating that the wireless communicator 102 is within range of operation with the base 104. The microcontroller will initiate registration 302 with the base. This indicates to the base 104 that the wireless communicator 102 is available to receive connection requests. Once registration has been authorized, the microcontroller 205 enters into the idle 303 state and goes into sleep mode. It is ready to receive any events from within the wireless communicator or from the base 104 via the Radio Interface 206. Periodically the microcontroller 205 will wake up from the idle state 303 and enter into the ping state 313 where it sends a ping message to the base 104 and waits to receive a response message to verify that the base is active and within range of the wireless communicator 102. If a response message is not received by a predetermined timeframe, the microcontroller will enter the out of range 315 state and sit there and wait for detection of an in range signal. If the response message is received, the microcontroller then returns to the idle state 303 and reenters sleep mode awaiting the next wakeup event.

In the idle 303 state, the microcontroller 205 can receive a connect request indication from the base 104 and enter the base connect request 314. In this state, the microcontroller 205 will establish the speech path between the radio interface and the microphone 201 and the speaker 208, and then send a positive acknowledgment to the base 104 indicating that the speech path has been successfully establish. The microcontroller 205 is now in the connected 308 State.

The microcontroller 205, when in the connected 308 state, may decide, either through the speech energy detection circuit 203 or by an expected pause in the active function logic being executed, that no speech data is being transferred between the wireless communicator 102 and the base 104. It can signal the base 104 to enter into the suspend 309 state and put the radio interface 206 into the suspend mode. In the suspend mode, the wireless speech path between the wireless communicator 102 and the base 104 is turned off, but the control path remains active. This greatly reduces battery drain in the communicator 102 during long silences in the conversation. The microcontroller 205 will enter the suspend 309 state upon positive acknowledgment from the base 104. If it receives a negative acknowledgment, then the microcontroller will remain in the connected 308 state indicating that the base 104 requires the speech connection to remain established. And vice versa, the base 104 can request suspend also, when it does not intend to communicate with the communicator 102. The wireless speech path is re-established 308 on a resume request.

In the idle 303 state, the microcontroller 205 can receive an indication 215 that a keyword phrase was spoken by the user 101 as detected by the speech recognition 209 circuit. The microcontroller 205 will wake up from its sleep and enter the keyword recognized 312 state. Based on the keyword phrase spoken, the microcontroller 205 will execute a predefined function 310, 311, 317 or resume executing a predefined function already in progress. Each predefined function can request to play an audio prompt or tone to the user to solicit further input from the user 102 or to indicate an acknowledgement or condition to the user 102. The microcontroller can engage with the base 104 in the process of executing a function either by establishing a speech path or by exchanging function-related data with the base 104 via a wireless data transfer channel 316 supported by the radio interface 206.

When the microcontroller 205 initiates a connect request 305 to the base 104, the base 104 will return a positive acknowledgment indicating that the speech path is established. In the next step 306, the contents of the speech capture buffer 204 is sent via 214 and 216 to the base 104 for processing, as needed. Finally, the microcontroller 205 enters into the connected state 308 thus completing the speech path from the base 104 to the wireless communicator microphone 201 and speaker 208 via paths 217 and 218, respectively. The microcontroller 205 then enters into low-power sleep mode. In this state, the base 104 is free to engage the user in any speech associated applications, including but not limited to regular phone conversations, voicemail, and IVR.

In another embodiment, when the microcontroller 205 is in the idle 303 state, it will wait until it receives signal 213 from the speech energy detection 203 circuit before initiating a connect request 305 to the base 104 as stated in the previous paragraph.

The microcontroller 205 can receive a disconnect request from the base 104 at any time. Any established connection is terminated and the microcontroller 205 goes to the idle 303 state. Any active function wraps up operation and is terminated, as well.

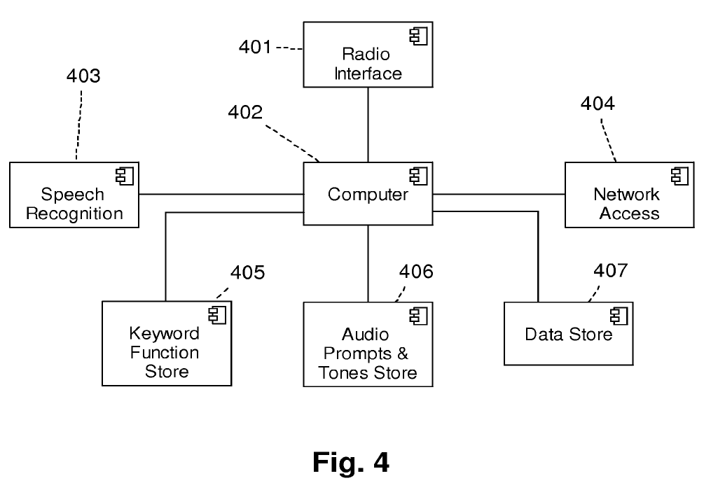

FIG. 4 identifies the main components of the base 104. The base is able to support one or more wireless communicator 102 connections. The Radio Interface 401 is used to communicate to each of the wireless communicators 102 that are registered with the base 104. The computer 402 interacts with the wireless communicator 102 and external services 105, 106, 107, 108 (via the network access 404) that may be used with the set of functions servicing the wireless communicator 102. These external services may also be used by functions executed on the base. 104.

The function store 405 contains the code for use by the computer 402 when needed. Audio prompts and tone store 406 contains speech prompts or tone indicators that can be played to the user 101, through the speaker of the wireless communicator 102, as necessary in the execution of a function. The speech recognition module 403 is used to convert received speech input into text as required during the execution of a function. The data store 407 contains necessary state information needed by the computer 402 for normal operation and normal execution of any of the functions.

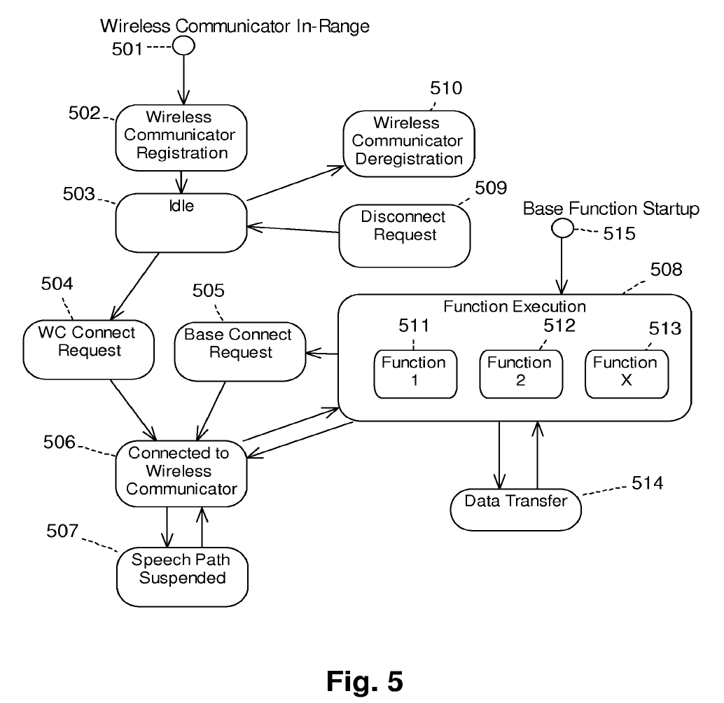

FIG. 5 identifies the general state machine executed by the computer 402. The radio interface 206 uses commercial digital wireless technology available today that supports voice and data transmission. When a wireless communicator 102 is within radio range 501 of the base 104, the wireless communicator 102 will send a registration request to the base 104. In this registration state 502, the computer 402 will authenticate and authorize valid registration requests and send back a positive acknowledgment and change to the idle state 503. In the idle state 503, the wireless communicator 102 will periodically send a “ping” message indicating that it is active and in range to the base 104. If a predetermined number of pings are not receives within a predetermined time then the computer will consider the wireless communicator 102 to be unavailable and will deregister it 510.

In the idle 503 state, the computer 402 can receive a connect request indication from the wireless communicator 102 and enter the WC connect request 504. In this state, the computer 402 will establish the speech path between the radio interface 401 and the speech recognition engine 403, and then send a positive acknowledgment to the wireless communicator 102 indicating that the speech path between the communicator 102 and the base 104 has been successfully establish. The computer 402 is now in the connected 506 State.

A base function can be started up 515, either by an internal function scheduler program of invocation by an external service, such that it initiates a base connect request 505 with the wireless communicator 102. Once established, the function can proceed to have a dialog with the user 101 and incorporating any of the services it has at hand 105, 106, 107, 108, 403, or 406.

The computer 402, when in the connected 506 state, may determine that no speech data is being transferred between the wireless communicator 102 and the base 104. It can signal the wireless communicator 102 to enter into the suspend state and thus greatly reduce battery drain during long silences in the conversation by turning off the wireless speech path. The computer 402 will enter the suspend 507 state upon positive acknowledgment from the wireless communicator 102. If it receives a negative acknowledgment, then the computer 402 will remained in the connected 506 state indicating that the wireless communicator 102 requires the speech connection to remain established. And vice versa, the wireless communicator 102 can request suspend also. The wireless speech path is re-established on a resume request.

In the connected 506 state, the computer 402 can engage the speech recognition 403 engine which can be a high end, large vocabulary recognizer. Based on the phrase spoken, the computer 402 will execute a predefined function 511, 512, 513 or resume executing a predefined function already in progress. Each predefined function can request to play an audio prompt or tone to the user to solicit further input from the user 102. The computer 402 can exchange function-related data with the wireless communicator 102 via a wireless data transfer channel 514 supported by the radio interface 401.

The computer 402 can receive a disconnect request at any time from the wireless communicator 102. Any established connection is terminated and the computer 402 goes to the idle state 503. Any active function wraps up operation and is terminated, as well.

While the foregoing written description of the invention enables one skilled in the art of computer hardware and software development to make and use what is considered presently to be the best mode thereof, those appropriately skilled will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A wireless communications apparatus comprising of:
I) a wireless communications device comprising of:
a) a microphone;
b) an analog to digital converter;
c) a digital to analog converter;
d) a speaker;
e) a microcontroller;
f) a speech energy detection circuit;
g) a speech capture buffer circuit;
h) a speech recognition circuit;
i) a radio interface circuit;
j) a keyword function store;
k) audio prompts and tones store;
l) data store;
m) said microphone detecting sound comprising of speech and converting said sound to a received analog audio signal;
n) said analog to digital converter converts received analog audio signal into a received binary digit stream whereby representing the received analog audio signal;
o) said speech energy detection circuit that continuously samples the received binary digit stream to measure speech energy based on a selected energy threshold and duration and turns on a speech energy signal whereby representing the start of the sustained speech energy;
p) said speech energy detection circuit that continuously samples the received binary digit stream to measure speech energy based on a selected energy threshold and duration and turns off a speech energy signal whereby representing the end of the sustained speech;
q) said speech capture buffer circuit begins capture of the received binary digit stream when it detects the speech energy signal turned on and stops capture when it detects the speech energy signal is turned off;
r) said speech recognition circuit analyses the captured received binary digit stream in the speech capture buffer and generates a recognized speech keyword signal when a match to a keyword phrase has been made;
s) said keyword function store comprising of a plurality of function code each indexed by a keyword phrase comprising of a plurality of words where a function code associated with the keyword phrase can be executed by said microcontroller;
t) said microcontroller when signaled by the speech recognition circuit with a keyword phrase selects the function code associated with said keyword phrase and begins executing said function program code;
u) said data store contains necessary state information needed by the microcontroller for normal operation and normal execution of any of the said plurality of function code.
v) said radio interface circuit used to communicate with the base for the transmission and reception of information comprising of radio control signals, two-way voice channel, and application data;
w) said microcontroller when required through normal operation or execution of function code will suspend by disconnecting and resume by re-connecting an established high-power-consuming two-way voice channel;
x) said microcontroller through normal operation or execution of function code signals the radio interface circuit to establish a high-power-consuming two-way voice channel on receiving any signal from the set of signals comprising of the turned on speech energy detected signal or the recognized speech keyword signal;
y) said microcontroller through normal operation or execution of function code sending a disconnect control signal to the radio interface circuit signals the radio interface circuit to disconnect the established high-power-consuming two-way voice channel;
z) said microcontroller through normal operation or execution of function code receiving a connect control signal from the radio interface circuit signals the radio interface circuit to establish high-power-consuming two-way voice channel;
aa) said microcontroller through normal operation or execution of function code receiving a disconnect control signal from the radio interface circuit signals the radio interface circuit to disconnect the established high-power-consuming two-way voice channel;
bb) said microcontroller through normal operation or execution of function code disconnects the established high-power-consuming two-way voice channel and signals the radio interface circuit to suspend the established high-power-consuming two-way voice channel due to a calculated period of no speech energy detected by the microcontroller during normal operation or execution of function code;
cc) said microcontroller through normal operation or execution of function code sends a resume signal to the radio interface circuit to re-establish the high-power-consuming two-way voice channel;
dd) said microcontroller through normal operation or execution of function code disconnects the established high-power-consuming two-way voice channel and signals the radio interface circuit to acknowledge the suspended high-power-consuming two-way voice channel due to receiving a suspend signal from the radio interface circuit by the microcontroller during normal operation or execution of function code;
ee) said microcontroller through normal operation or execution of function code receiving a resume signal from the radio interface circuit signals the radio interface circuit to re-establish the high-power-consuming two-way voice channel;
ff) said digital to analog converter converts output binary digit stream into an output analog signal to be fed to the said speaker;
gg) said speaker receiving said output analog audio signal from said digital to analog converter and converting said output analog audio signal to sound whereby a person may hear; and
hh) said audio prompts and tones store of verbal phrases for playing to the user by the microcontroller during normal operation or the execution of keyword functions;
II) and an associated wireless communications base with which to relay said radio control signals, said two-way voice channel, and said application data with said wireless communications device comprising of:
a) a computer;
b) said radio interface circuit used to communicate in a reciprocal manner with the wireless communications device radio interface circuit for the transmission and reception of information comprising of radio control signals, two-way voice channel, and application data;
c) said computer handling said radio interface circuit is a reciprocal manner to the wireless communications device;
d) a public telephone network access interface to access a plurality of telephone devices and audio-based media servers;
e) a public data network access interface to access a plurality of data-based application servers
f) said computer hosting a plurality of features and services made available to the wireless communications device;
g) a keyword function store containing program code that begins execution based on the keyword phrase spoken by the user or as needed by the microcontroller in the execution of a task;
h) an audio prompts and tones store of verbal phrases for playing including but not limited to the user during the execution of keyword functions; and
i) a speech recognition engine used to recognize any spoken phrases by the user or other speech source including but not limited to an external voice channel.

2. A method for a wireless communications apparatus comprising of:
a) optimizing the power of the wireless communications device through the microcontroller program execution by applying only necessary power to a subset of circuits comprising of a radio interface circuit, a speech energy detection circuit, a speech capture buffer circuit, a speech recognition circuit, and a microcontroller;
b) waiting for a detection signal by the microcontroller in the low power state from any wireless communications device circuit;
c) responding to any signals by the microcontroller comprising of a detected speech energy signal, a not detecting speech energy signal, a keyword phrase detected signal and radio interface incoming connect request signal.
d) suspending an established two-way voice channel between the wireless communications device and the wireless communications base when appropriate whereby greatly reducing power consumption on the wireless communications device; and
e) resuming an suspended two-way voice channel between the wireless communications device and the wireless communications base when appropriate whereby using power only as necessary on the wireless communications device;

3. The method in claim 2, wherein said waiting for a detection signal by the microcontroller further comprises:
a) detected speech energy signal when microphone speech sampling meets start speech energy threshold and duration;
b) not detecting speech energy signal when microphone speech sampling meets end speech energy threshold and duration;
c) capturing speech data by a speech capture buffer circuit when detected speech energy signal asserted;
d) stop capturing speech data by the speech capture buffer circuit when detecting speech energy signal not asserted;
e) keyword phrase detected signal when keyword phrase has been found by the speech recognition circuit;
f) establishing two-way voice channel when speech energy signal asserted; and
g) establishing two-way voice channel when keyword phrase detected signal asserted;
h) establishing two-way voice channel when incoming voice channel connect request is received from the radio interface;

4. The method in claim 2, wherein said responding to any signals by the microcontroller further comprises:
a) means of transferring collected speech signal in the speech capture buffer to the radio interface circuit two-way voice channel;
b) means of routing speech data between the radio interface circuit two-way voice channel and a microphone analog to digital converter and speaker digital to analog converter circuits;
c) means of engaging the radio interface circuit two-way voice channel when signaled by the speech energy detection circuit;
d) means of engaging the radio interface circuit two-way voice channel when signaled by the speech recognition circuit;
e) means of executing a keyword function when signaled by the speech recognition circuit with a keyword phrase; and
f) means of routing speech data from the audio prompts and tone store to the speaker digital to analog converter;
